(19) United States
(12) Patent Application Publication
(10) Pub. No.: US 2006/0202393 A1
(43) Pub. Date: Sep. 14, 2006

(54) Process for the production of carbon bodies

(76) Inventors: James William Kortovich, Avon Lake, OH (US); Allan W. Intermill, Strongsville, OH (US)

Correspondence Address: WADDEY & PATTERSON, 1600 DIVISION STREET, SUITE 500, NASHVILLE, TN, 37203, US

(21) Appl. No.: 11/075,372

(22) Filed: Mar. 8, 2005

(51) Int. Cl. C01B 31/02; C01B 31/04

(52) U.S. Cl. 264/449; 264/29.1; 264/29.7

(57) ABSTRACT

A method of forming a graphitic carbon body employs compression and resistance heating of a stock blend of coke and pitch. Preferably, the stock includes raw coke, high melting point pitch, and carbon fibers derived from pitch. Optionally, the stock may also include calcinated coke, graphite, carbon fibers, coal tar or petroleum pitch, or coking catalysts such as sulfur. During molding of the body, resistance heating is accompanied by application of mechanical pressure to increase the density and carbonization of the resulting preform body. The preform is then subjected to a graphitization temperature to form a graphitic carbon body, such as a graphite electrode or pin. Optionally, after hot-pressing, the preform electrode or pin may be subjected to one or more densification steps employing a carbonizable pitch to further increase the density of the preform prior to the graphitization step.

We, James William Kortovich, a citizen of the United States, residing at 10325 Juniper Court, Strongsville, Ohio 44136, and Allan W. Intermill, a citizen of the United States, residing at 21571 Hickory Branch Trail, Strongsville, Ohio 44149, have invented a new and useful “Improved Process for the Production of Carbon Bodies.”

### BACKGROUND OF THE INVENTION

The present invention relates generally to processes for forming carbon bodies, such as graphite electrodes and connecting pins. More particularly, the invention concerns a method of forming graphite electrodes and connecting pins by resistively heating a blend of coke, pitch and carbon fibers during application of compressive force.

Carbon electrodes are used in electrothermal furnaces to melt metals and other ingredients used to form metal alloys. (As used herein, the term carbon electrodes includes graphite electrodes.) Generally, the electrodes used in steel furnaces each consist of electrode columns, that is, a series of individual electrodes joined to form a single column. In this way, as electrodes are depleted during the thermal process, replacement electrodes can be joined to the column to maintain the length of the column extending into the furnace. These electrodes are joined into columns via a connecting pin that functions to join the ends of adjoining electrodes. Conventionally, electrodes are joined into columns via a pin (sometimes referred to as a nipple) that functions to join the ends of adjoining electrodes. Typically, the pin takes the form of opposed male threaded sections, with at least one end of each of the electrodes comprising female threaded sections capable of mating with a male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint.

Alternatively, the electrodes can be formed with a male threaded protrusion or tang machined into one end and a female threaded socket machined into the other end, such that the electrodes can be joined by threading the male tang of one electrode into the female socket of a second electrode, and thus form an electrode column. The joined ends of two adjoining electrodes in such an embodiment is referred to in the art as a male-female joint.

Carbon electrodes and pins may be fabricated by combining calcined petroleum coke and coal-tar pitch binder into an stock blend. In this multi-step process, the calcined petroleum coke is first crushed, sized and milled into a finely defined powder. Generally, particles up to about 25 millimeters (mm) in average diameter are employed in the blend. The particulate fraction preferable includes coke powder filler having a small particle size. Other additives that may be incorporated into the small particle size filler include iron oxides to inhibit puffing (caused by release of sulfur from its bond with carbon inside the coke particles), coke powder and oils or other lubricants to facilitate extrusion of the blend.

The stock blend is heated to the softening temperature of the pitch and is form pressed to create a “green” stock body such as an electrode or pin. For green electrode production, a continuously operating extruding press may be use to form a cylindrical rod known as a “green” electrode. For pin production, the green pin body is formed by die extrusion or by molding in a forming mold to form a “green pinstock”.

The green stock body is heated in a furnace to carbonize the pitch so as to give the body permanency of form and higher mechanical strength. Depending upon the size of the electrodes or pins and upon the specific manufacturer's process, this “baking” step requires the green electrodes or pinstock to be heat treated at a temperature of between about 700° C. and about 1100° C. To avoid oxidation, the green stock body is baked in the relative absence of air. The temperature of the body is raised at a constant rate to the final baking temperature. For electrode or pin production, the green stock body is maintained at the final baking temperature for between 1 week and 2 weeks, depending upon the size of the electrode.

After cooling and cleaning, the baked electrode or pin may be impregnated one or more times with coal tar or petroleum pitch, or other types of pitches known in the industry, to deposit additional pitch coke in any open pores of the electrode or the pin. Each impregnation is then followed by an additional baking step, including cooling and cleaning. The time and temperature for each re-baking step may vary, depending upon the particular manufacturer's process. Additives may be incorporated into the pitch to improve specific properties of the graphite electrode or pin. Each such densification step (i.e. each additional impregnation and re-baking cycle) generally increases the density of the stock material and provides for a higher mechanical strength. Typically, forming each electrode or pin includes at least one densification step. Many such articles require several separate densification steps before the desired density is achieved.

After densification, the electrode or pin, referred to at this stage as carbonized body, is then graphitized. Graphitization is by heat treatment at a final temperature of between about 1500° C. to about 3400° C. for a time sufficient to cause the carbon atoms in the calcined coke and pitch coke binder to transform from a poorly ordered state into the crystalline structure of graphite. At these high temperatures, elements other than carbon are volatilized and escape as vapors.

After graphitization is completed, the electrode or pin can be cut to size and then machined or otherwise formed into its final configuration. Given its nature, graphite permits machining to a high degree of tolerance, thus permitting a strong connection between pin and electrode in a joint system or between electrode and electrode in a male-female joint system. Machining the graphitized electrode removes only a small fraction of the overall mass of the electrode, while machining the graphitized pin typically removes up to about 40% or more of the mass of the pin. Thus, the material yield is only about 60% for manufacture of connecting pins.

The lengthy densification cycles greatly increase the expense and time of manufacture of graphite electrodes and pins. For example, it may take about six months to form a graphite pin, depending on the number of densification steps. Graphite electrodes may take about 35 days to manufacture, again depending on the number of densification steps. Such long lead times require greater inventories of raw, in process and finished goods to accommodate fluctuations in both the demand for the finished goods and the supply of raw materials. Moreover, manufacturing processes such as the above described manufacture of graphite electrodes and pins require significant capital cost and labor expense to repeat the lengthy baking and impregnation cycles. Even a reduction of one such cycle would represent significant savings in capital cost, inventory carrying cost and labor expense.

### BRIEF SUMMARY OF THE INVENTION

The present invention provides a new and improved method of forming a carbon body, such as graphite electrode or pin, which overcomes the above-referenced problems and others.

Aspects of the present invention include a method of forming a carbon body, such as a graphite electrode or pin. The method includes combining coke, pitch and, optionally, carbon fibers to form an stock mixture and heating the stock mixture to a sufficient temperature to carbonize at least a portion of the mixture so as to form a preform body. The hot pressing step includes resistive heating by applying an electric current to the stock mixture such that heat is generated within the mixture. While heating the mixture, a pressure is applied to the stock mixture to form an at least partially carbonized stock mixture.

In accordance with one aspect of the present invention, the hot pressing step provides a significant reduction in the process time required to carbonize a stock mixture. Exemplary preform process times include a process time of about 5 minutes for a 20-25 kilogram (kg) carbon body such as a pin and a preform process time of about 6 hours for a 900 kg carbon body such as an electrode.

In accordance with another aspect of the present invention, the hot pressing step provides for use of high melting point pitch as a component of the stock mixture. High melting point pitch accords a significant increase in the obtainable coking yield of the pitch component during carbonization as compared to previously known methods. One embodiment of the method of this invention provides a coking yield of up to about 80% as compared to a typical coking yield of about 60% or lower.

In accordance with another aspect of the present invention, the method provides a preform body having gross dimensions sufficiently approximate to the desired machined dimensions of the final graphitized carbon body so as to provide a significant increase in the obtainable material yield, i.e. the amount of the graphitized mass remaining after machining, as compared to previously known methods. One embodiment of the method of this invention provides a carbon pin formed with opposed tapered male sections having a material yield of up to about 80% as compared to a typical material yield of about 60% or lower.

In accordance another aspect of the present invention, the hot pressing step provides that compressive molding pressure is applied perpendicularly to the longitudinal axis of the preform formed within the hot press mold so as to result in a preform having longitudinally preferred orientation.

### BRIEF DESCRIPTION OF THE SEVERAL VIEWS OF THE DRAWINGS

FIG. 1 is a flow chart showing stages and steps of an exemplary process scheme for forming a carbon electrode or pin according to the present invention.

FIGS. 2A-2D are details of the flow chart of FIG. 1 showing alternate exemplary process schemes of the steps of the stock mixing stage.

FIGS. 3A and 3B are details of the flow chart of FIG. 1 showing the alternate exemplary process schemes of the steps of the hot pressing stage.

FIG. 4 is a detail of the flow chart of FIG. 3B showing an exemplary process scheme of the compressive molding and resistive heating steps of the hot pressing stage.

FIGS. 5A and 5B are details of the flow chart of FIG. 1 showing the alternate exemplary process schemes of the steps of the graphitization stage.

### DETAILED DESCRIPTION OF THE INVENTION

A method of forming a carbon electrode or pin for use in high temperature applications, such as steel arc furnaces, employs resistance heating of an stock blend of coke, pitch and, optionally, carbon fibers, or other suitable mixture of carbon filler, reinforcement and matrix materials. Preferably, the stock blend includes raw coke, high melting point pitch and carbon fibers derived from pitch. Optionally, the stock blend may also include calcinated coke, graphite, carbon fibers, coal tar pitch, petroleum pitch, or coking catalysts such as sulfur. As desired, additives may be added to improve the processing characteristics of the blend or to improve the physical characteristics of the graphite electrode or pin. Such additives may be added during mixing or after forming the stock blend. During the hot pressing step, resistance heating is accompanied by application of mechanical pressure (“hot-pressing”) to increase the density and carbonization of the blend. The resulting carbonized body or “preform” is preferably subjected to graphitization after hot-pressing by heating the preform to a final temperature of between about 1500° C. to about 3400° C. to remove remaining non-carbon components and form a material which is almost exclusively graphite. Optionally, after hot-pressing, the preform electrode or pin may be subjected to one or more densification steps employing a carbonizable pitch to further increase the density of the preform prior to the graphitization step.

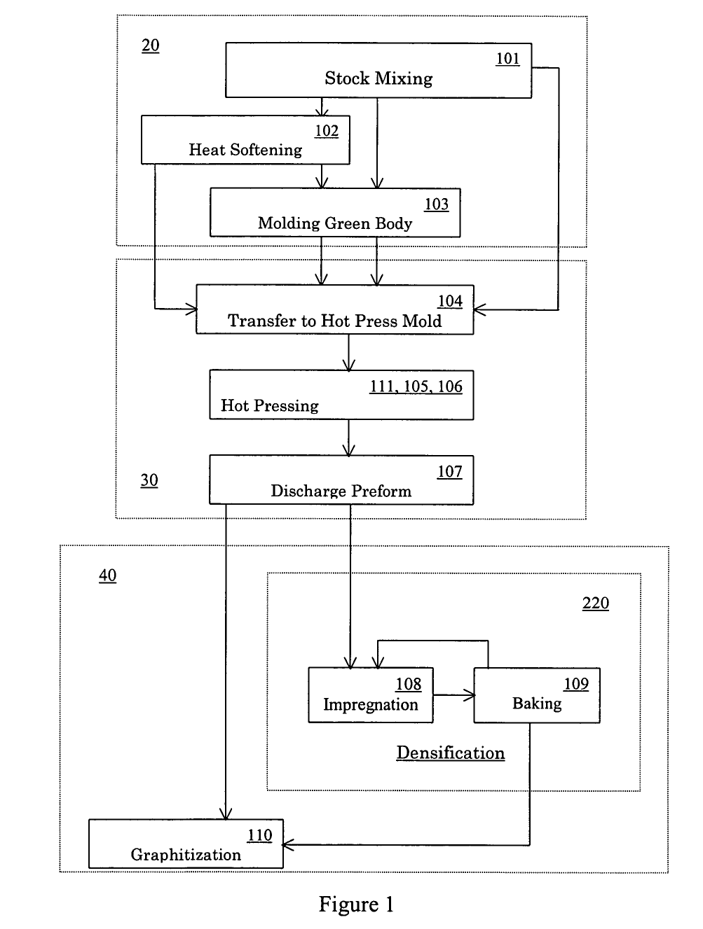

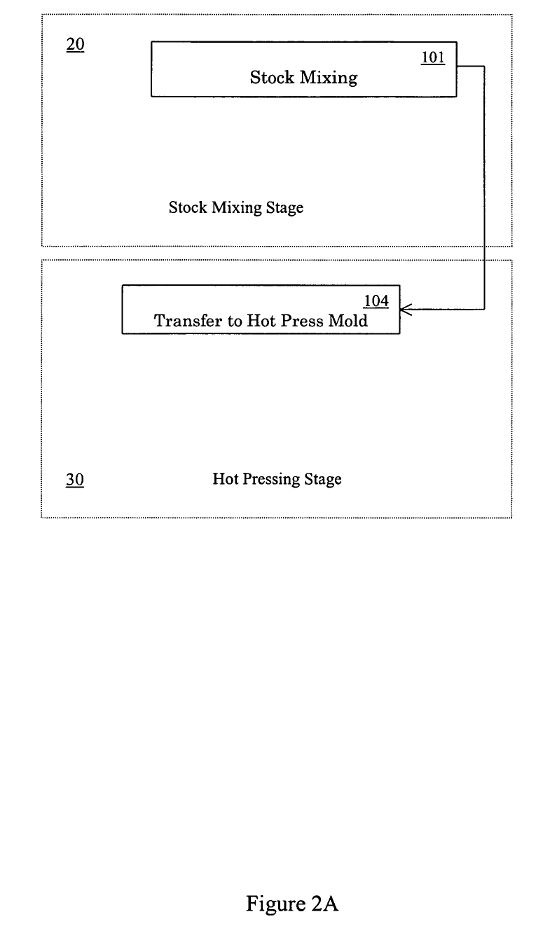

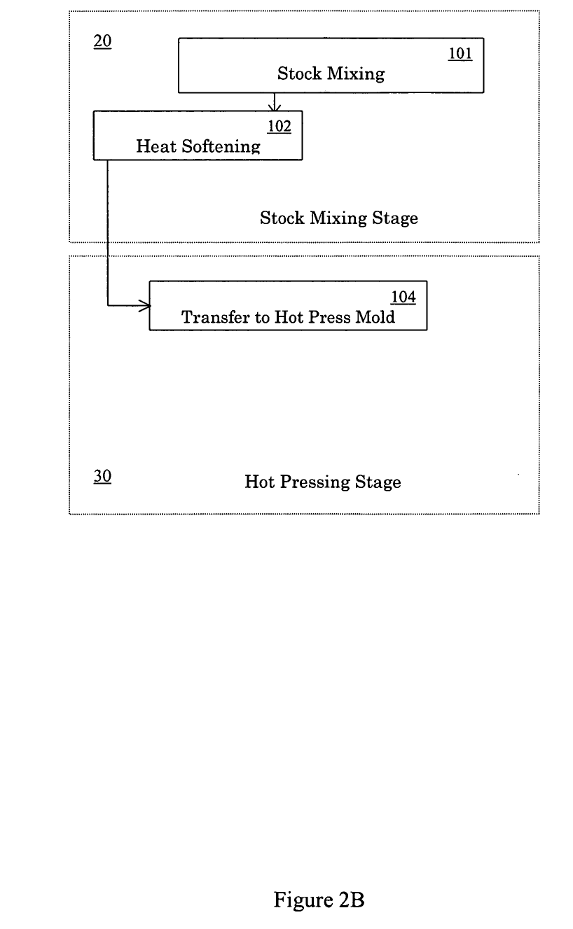

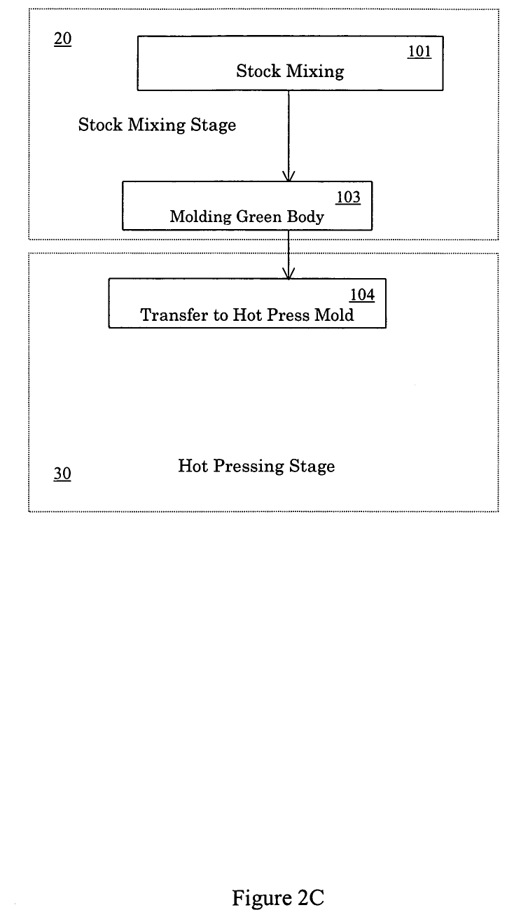

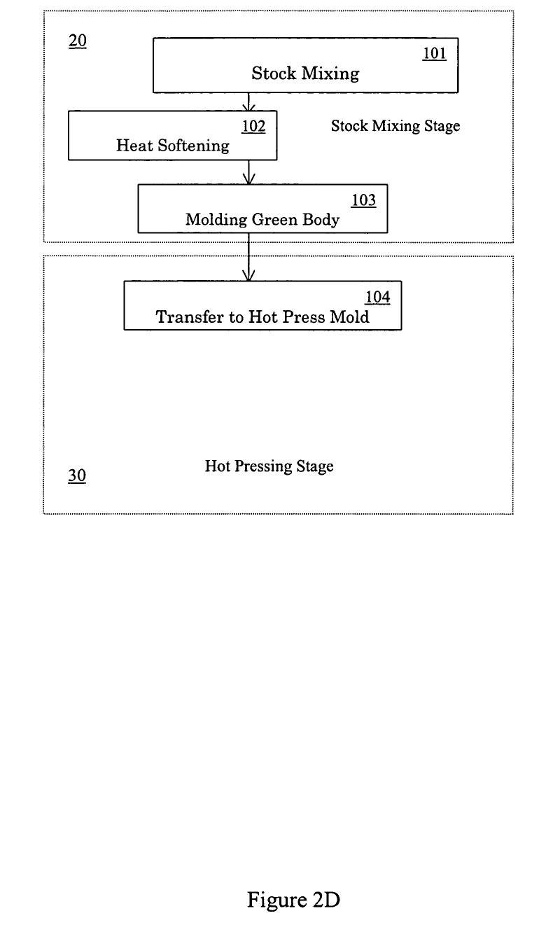

With reference to FIG. 1, a flow chart representing the sequence of stages of in exemplary process schemes of this inventive process for the manufacture of carbon bodies, such as graphite electrodes or pins, is shown. Generally, blend components are mixed in a stock mixing stage 20 and are then at least partially carbonized in a hot pressing stage 30 to produce a perform carbon body. Finally, the preform carbon body is graphitized in a graphitization stage 40. With reference to FIGS. 2A-2D, 3A, 3B, 4, 5A and 5B, flow chart details representing alternate sequences of steps of in exemplary process schemes of the various stages of this inventive process are shown.

Referring now to FIGS. 1 and 2A, in Step 1 101, coke, pitch and carbon fibers, or other suitable mixture of carbon filler, reinforcement and matrix materials are combined to form an stock mixture. Preferably, the stock mixture includes raw coke, high melting point pitch and carbon fibers derived from pitch. Optionally, the stock mixture may also include calcinated coke, graphite, carbon fibers, coal tar pitch, or petroleum pitch. Additionally, coking catalysts such as sulfur may be incorporated into the stock to improve the coking yield of the binder. Optionally, yet other carbonizable and carbonaceous additives, may be incorporated into the blend to improve the physical characteristics of the end product graphite body and/or the processing characteristics of the stock mixture, such as the softening temperature of the stock mixture during molding or the electrical conductivity of the stock mixture during resistance heating.

Suitable fillers include raw coke, calcinated coke, and graphite. The filler is preferably in the form of flour, powder or other finely divided material having an average particle size of less than about 25 milimeters in average diameter.

Suitable carbon fibers for use in the stock mixture include those formed from pitch, such as mesophase pitch. The particular choice of carbon fibers depends on the anticipated requirements of the graphitic carbon body. The carbon fibers provide an independent source of carbon upon pyrolytic decomposition.

The pitch is fusible (i.e., capable of melting) and contains both volatile and non-volatile components. The pitch decomposes on heating to form an infusible material which is primarily carbon with the release of volatiles. Preferred pitch materials are high melting point pitches and, more preferably, pitches having Mettler softening point temperatures of between about 120° C. and about 350° C., and more preferably, between about 150° C. and about 200° C. Preferred pitch materials include pitches with carbon yields of about 70% or higher, or more preferably of about 80% or higher upon coking. However the invention is not limited to the use of high melting point pitches. Suitable pitches also include coal tar or petroleum pitches, including pitches having Mettler softening point temperatures of between about 100° C. and about 120° C., and optionally, between about 70° C. and about 120° C. Pitches with carbon yields of about 50% or higher upon coking may also be used to practice the invention. It is also contemplated that synthetically formed pitch may be used to practice the invention. Pitch and sulfur mixtures are also suitable. Suitable pitches include pitches that are liquid or semi-liquid or that are crushed or milled into finely comminuted solids. However the invention is not limited to the use of finely comminuted solids, non-finely comminuted solids may also be used to practice the invention.

With continued reference to FIGS. 1 and 2A, preferably, the mixture is prepared in Step 1 101 by “dry mixing,” i.e., mixed without addition of solvents and at a temperature at which the pitch material is still a solid. Then, in Step 4 104, the dry mixed stock mixture is transferred to a hot press mold prior to being hot pressed as described below.

With continued reference to FIG. 1 and now to FIG. 2B, in an optional Step 2 102, the mixture is further prepared by “heat softening,” wherein heat is applied during the mixing phase to raise the temperature of the pitch above its softening point, which is generally between about 70° C. and about 350° C. If heat softened during mixing, then preferably the stock mixture is heated to about 30° C. or more above the Mettler softening point of the pitch to reduce the viscosity of the stock mixture. While the mixing processes of Step 1 101 and/or Step 2 102 are preferably carried out in the absence of additional liquids, such as water or an organic solvent, it is also contemplated that a small amount of an organic solvent may be mixed with the stock mixture to act as a plasticizer for the pitch material and to reduce the mixing temperature.

With continued reference to FIG. 1 and now to FIG. 2C, optionally in Step 3 103, the dry mixed stock mixture is molded into a green carbon body, such as a green electrode or green pin, prior to being hot pressed as described below. In one embodiment of Step 3 103, the stock mixture is packed into a molding form separate from the hot press mold and pressed into a green electrode or green pin having dimensions only slightly smaller than those of the hot press mold cavity. For electrode production, a continuously operating extruding press may be use to form a green electrode. For pin production, a green pin may be formed by either die extrusion or molded in a shaping mold separate from the hot press mold.

With continued reference to FIG. 1 and now to FIG. 2D, optionally in Step 2 102 and Step 3 103, the dry mixed is first heat softened to provide a heat softened stock mixture. The heat softened mixture is then molded into a green carbon body as described above prior to being hot pressed as described below.

Referring now to FIGS. 1 and 2A-2D, the materials produced in the stock mixing stage 20 and transferred to the hot press mold in Step 4 104 is herein termed the “hot press mixture”. Depending on the particular process scheme selected, the term “hot press mixture” will describe either a dry mixed stock mixture (FIG. 2A), a heat softened stock mixture (FIG. 2B) or a green carbon body (FIGS. 2C and 2D).

Referring again to FIG. 1, during the hot pressing stage 30, the hot press mixture is hot pressed to create a preform body, such as a preform electrode or pin. In the hot pressing process, the hot press mixture is heated to a sufficient temperature to melt at least a portion of the stock material. This heating step includes applying an electric current to the hot press mixture such that heat is generated within the mixture. While heating the hot press mixture, a pressure is applied to the mixture to form a preform electrode or pin that is at least partially carbonized.

In one embodiment of the present invention, a hydraulic hot press assembly suited to resistively heat and hydraulic compress a hot press mixture (i.e. the dry mixed stock or, optionally, the heat softened stock or the green electrode or pin) is employed to manufacture a preform carbon body, such as a preform electrode or pin. One exemplary hydraulic hot press assembly includes a hydraulic press having an integrally attached hot press mold, the mold having a cavity shaped to receive the hot press mixture and form the desired preform. Preferably, the hot press mold is shaped to the approximate dimensions of the desired graphitized carbon body, such as a graphite pin or electrode. Additionally, the hot press mold is preferably contained within a thermally insulated housing. Pressure is applied to the hot press mixture by hydraulic pistons, and is preferably applied so as to achieve a uniform pressure along the mixture. The application of pressure is also preferably in a molding direction perpendicular to the longitudinal axis of the preform so as to obtain a longitudinally preferred carbon body, i.e. having a crystalline structure oriented so as to provide the greatest tensile strength along the longitudinal axis of the body. In a preferred configuration, the hot press mold will be oriented so as to mold the preform with its longitudinal axis in a horizontal plane. Pressure is then applied to the hot press mixture by upper and/or lower vertical hydraulic pistons operating in single or double action.

In a preferred embodiment, the ends of the hot press molds are stainless steel end plates, which are in electrical contact with the hot press mixture. A resistive heating system applies an electrical current to the hot press mixture through these end plates. In a more preferred embodiment, the pistons and the hot press mold each have a silicon carbide surface liner and are both electrically insulated from the frame of the hydraulic hot press assembly. The resistive heating system includes a source of electrical power for providing a high current at low voltage, such as a DC supply. High AC currents are also contemplated. The DC or AC supply is electrically connected with the stainless steel end plates. The construction of the hydraulic hot press assembly is such that all parts of the hot press mixture within the hot press mold cavity are subjected to a substantially uniform current flow. Resistively heating and compressively molding the hot press mixture under current and pressure conditions that are generally uniform throughout the hot press mixture results in substantially uniform characteristics throughout the preform electrode or pin and further results in a significant reduction in fissures and other irregularities, which tend to result in fracture during use. Preferably, a programmed application of the current and pressure provides, among other things, hot press mixture temperatures, pressures, heating rates and pressurization rates in accordance with a desired baking process, the calculations of which are based upon specific stock kinetics. More preferably, a programmable control system integral to the hydraulic hot press assembly provides such a programmed application of current and pressure.

Referring again to FIG. 1, in Step 4 104, the hot press mixture is transferred to the cavity of a hot press mold. In an alternative embodiment (FIG. 2C or 2D), a green carbon body is the hot press mixture transferred to the cavity of a hot press mold. In an alternative embodiment (FIG. 2B), Step 3 103 is eliminated and the heat softened stock mixture is the hot press mixture transferred directly to the hot press mold cavity from the mixer. In a preferred embodiment (FIG. 2A), Step 2 102 and Step 3 103 are eliminated and the dry mixed stock mixture is the hot press mixture transferred directly to the hot press mold cavity from the mixer.

In a preferred embodiment of Step 4 104 for smaller carbon body production such as pin production, the hot press mold is integrally attached to the hydraulic press. However, in a preferred embodiment of Step 4 104 for larger carbon body production such as electrode production, the hot press mold is external and independent of the hydraulic press of the hydraulic press assembly. In this embodiment, the hot press mixture is transferred to the cavity of a movable hot press mold in a mold filling station. After filling of the hot press mold, the mold is placed within the hydraulic press for compression. The hot press mold is of a similar design as described above, having silicon carbide lined sides and stainless steel endplates used to provide electrical contacts.

Referring again to FIG. 1, the hot pressing step, Step 11, 111 includes a resistive heating step, Step 6, 106 and a compressive molding step, Step 5 105, performed on the hot press mixture so as to form an at least partially carbonized stock mixture. The resistive heating step, Step 6, 106, is accomplished by applying an electric current to the stock mixture such that heat is generated within the mixture. The compressive molding step, Step 5 105, is accomplished by applying a pressure to the stock mixture. In one preferred embodiment the pressure is applied in a manner that results in a generally uniform pressure throughout the hot press mixture. In another preferred embodiment pressure is applied to the hot press mixture in a molding direction perpendicular to the longitudinal axis of the preform so as to obtain a longitudinally preferred carbon body.

With continued reference to FIG. 1 and now 3A, a preferred process scheme is shown wherein the hot pressing step, Step 11 111, includes at least a partial overlapping of the resistive heating step, Step 6 106, and the compressive molding step, Step 5 105. While the present invention is drawn to the exemplary process schemes shown, it is contemplated that the hot pressing step, Step 11 111, also encompasses those process schemes with no overlapping of the resistive heating step, Step 6 106, and the compressive molding step, Step 5 105. Specifically contemplated are process schemes having sequential performance of Step 6 106 and Step 5 105 or having alternating or cyclic performance of Step 6 106 and Step 5 105.

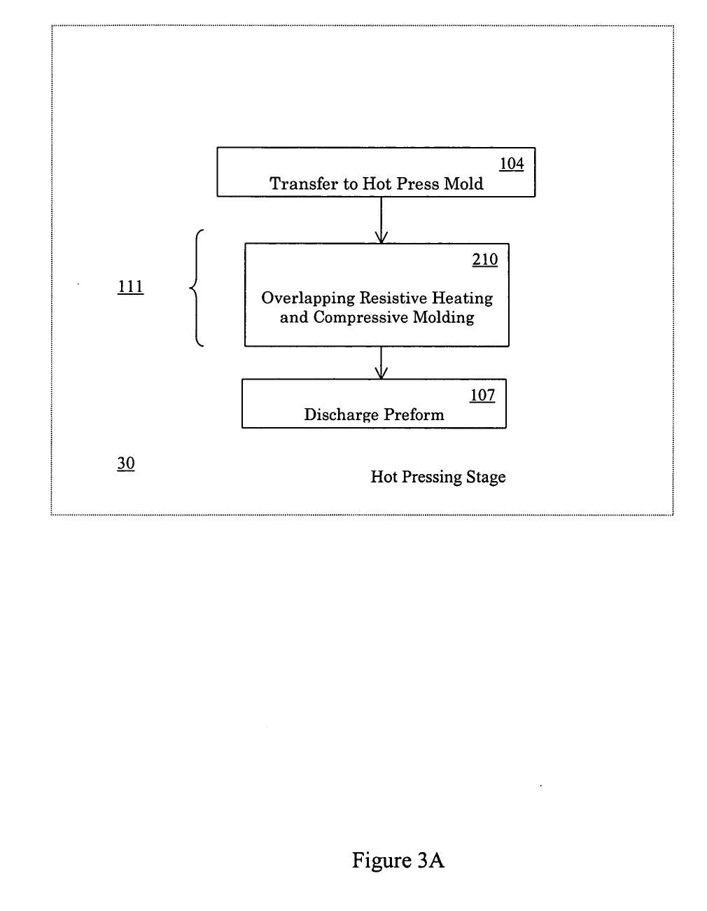

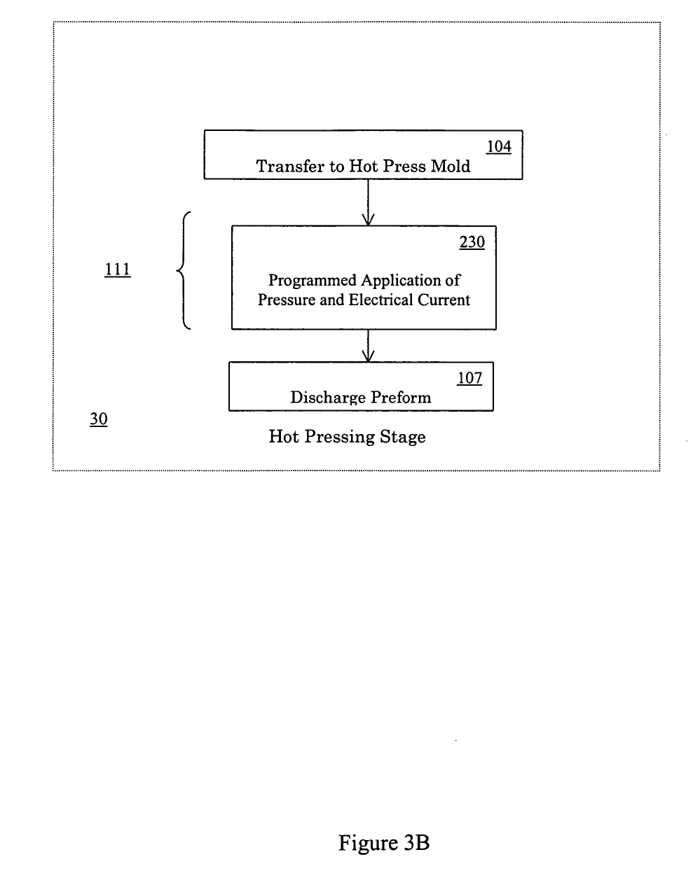

With continued reference to FIG. 1 and now to FIG. 3B, a more preferred process scheme is shown wherein the hot pressing step, Step 11 111, includes at programmed application 230 of the current and pressure such that the resistive heating step, Step 6 106, and the compressive molding step, Step 5 105, provides hot press mixture temperatures, pressures, heating rates and pressurization rates in accordance with a desired baking process, the calculations of which are based upon specific stock kinetics.

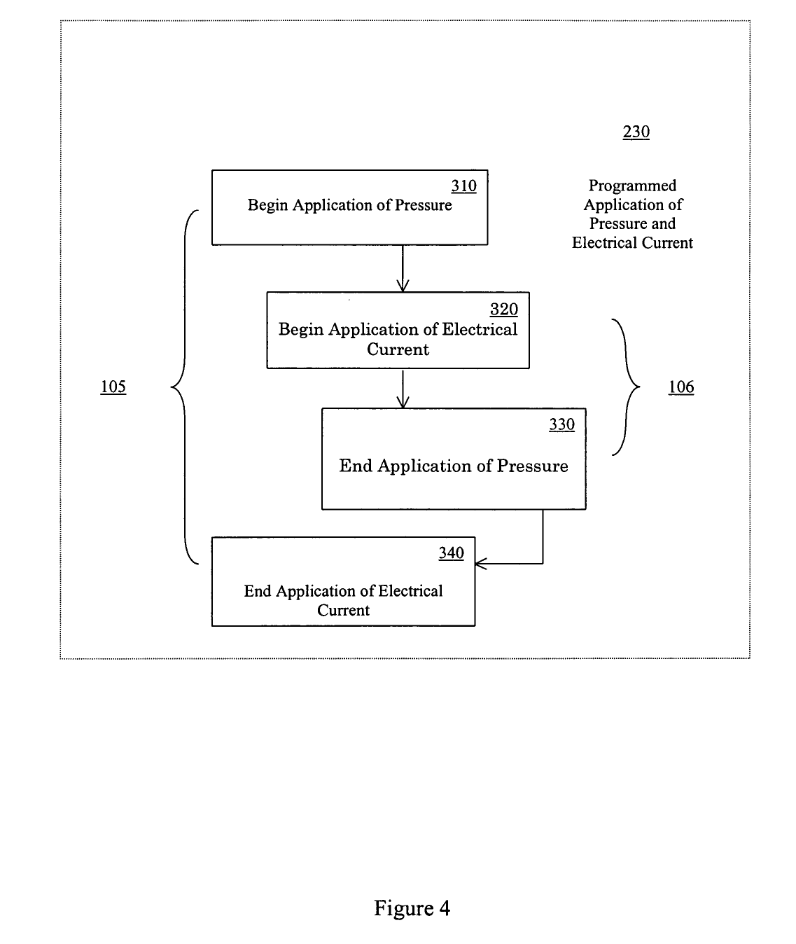

With continued reference to FIG. 1 and now to FIG. 4, an exemplary process scheme is shown wherein the programmed application 230 includes in Step 5 105, a start of application of pressure 310 to compress the hot press mixture, maintaining the application of pressure for a period of time, followed by and end of application of pressure 340. The pressure applied is partly dependent on the desired final density of the graphite electrode or pin. In a preferred embodiment of Step 5 105, a control system integral to the hydraulic hot press assembly provides a programmed application of pressure.

With continued reference to FIGS. 1 and 4, the programmed application 230 also includes in Step 6 106, a start of application of electrical current 320 to resistively heat the hot press mixture, maintaining the application of electrical current for a second, overlapping period of time, followed by and end of application of electrical current 330. In a preferred embodiment of Step 6 106, the control system provides a programmed application of temperature. It is contemplated that heating may commence concurrently with, or before the start of the application of pressure. It is also contemplated that heating may terminate concurrently with, or after the end of the application of pressure. Preferably, both heating and application of pressure are carried out concurrently, for at least a part of the process time, to densify the material as the volatile materials are driven off.

With continued reference to FIG. 1 and now to FIGS. 3a and 3B, the temperature of the hot press mixture during the hot pressing step, Step 11 111 (Steps 5 and 6 105, 106), is preferably sufficient to melt the pitch, and optionally remove at least some of the volatiles from the pitch, and facilitate compression of the mixture as the pitch material is rigidized. It should be appreciated that, since pitch is generally not a homogeneous material, a portion of the pitch matrix material may remain unmelted, even at temperatures significantly above the softening point. Additionally, while substantially all the volatiles are removed in this step, it is also contemplated that a portion of the volatiles may remain without unduly affecting the properties of the preform material.

During the hot pressing step, Step 11 111 (Steps 5 and 6 105, 106), of another exemplary process scheme of this invention, the resistance heating rapidly heats the entire hot press mixture to a suitable temperature for removal of volatile materials and carbonization of the pitch creating voids or bubbles within the mixture. Mechanical pressure is applied to densify the hot press mixture as the applied heat drives off the volatile materials. The hot press mixture preferably reaches a temperature of above the carbonization temperature, which is about 500° C. in the case of pitch. For example, the mixture is heated to at least about 700° C., more preferably, between about 800° C. and about 900° C., although higher temperatures are also contemplated. The power input applied during resistive heating depends on the resistance of the hot press mixture and the desired program temperatures.

In a preferred process scheme of this invention, a programmed application of current and pressure process is applied by a programmable control system of the hydraulic press assembly. In one exemplar programmed application process, the control system may initially apply a relatively low power input for a period of time during an initial phase of the compressive and resistive heating. In this phase, the temperature is preferably in the range of about 300° C. to 500° C. The bulk of the volatiles are removed from the hot press mixture in this temperature range. The temperature is preferably kept below the curing temperature of the pitch material during this phase. At a preprogrammed condition, such as an elapsed time and temperature, the temperature is increased to a higher temperature (e.g., above about 700° C., more preferably, about 800° C.) and the pitch is carbonized.

In such an exemplary programmed application process, the control system may apply different pressures dependent upon preprogrammed conditions, such as, among other things, temperature and process time. The lower pressure may be applied during initial heating so as to reduce the opportunity for volatile gases to be trapped in the hot press mixture and so as to prevent violent disruption of the mixture as they escape.

The hot pressing step, Step 11 111 (Steps 5 and 6 105, 106), of the present invention is contemplated to include such other programmed applications 230 of electrical current and pressure as may be performed by the exemplary hydraulic press assembly or other resistive heating and compressive molding devices so as to provide various temperatures and pressures within the stock mixture according to a desired time, temperature and pressure program, depending upon the kinetics of the stock mixture and the desired graphite body.

The hot pressing step, Step 11 111 (Steps 5 and 6 105, 106), provides a preform having an stock mass that has been substantially carbonized. Advantageously, the hot pressing step, Step 11 111 (Steps 5 and 6 105, 106), provides for use of high melting point pitch as a component of the stock mixture. High melting point pitch accords a significant increase in the obtainable coking yield of the pitch component during initial carbonization as compared to previously known methods. One embodiment of the method of this invention, the preform provided by the hot pressing step, Step 11 111 (Steps 5 and 6 105, 106), has a coking yield of up to about 80% as compared to a typical coking yield of about 60%. This high coking yield reflects a substantially greater degree of carbonization and density of the preform of this invention than comparable carbonized bodies produced in the initial baking step of conventional methods.

The hot press mold cavity may be configured to produce a preform cast so as to closely approximate the dimensions of a finished carbon body, such as a graphite electrode or pin, thereby reducing the need for subsequent machining to form a desired component part. For pin production, the preform molded shape may be cast with sufficient dimensional precision as to allow for up to 80% material yield upon machining to final pin dimensions, as compared to a typical material yield of about 60% or lower.

With reference to FIG. 1, in a one preferred process scheme in step 7 107, the at least partially carbonized preform is discharged from the hot press mold cavity and cooled. Preferably, the preform is cooled rapidly to a temperature below which oxidation does not occur at a significant rate. For example, the preform is immersed in water or sprayed with droplets or a mist of water to bring its temperature below about 400-500° C. Alternatively, cooling may be achieved with an inert gas flow. Preferably, the preform is cooled at a rate to avoid cracking of the preform.

Optionally, in step 7 107, the hot-pressed preform may be discharged directly from the mold cavity and without significant cooling to either a furnace for graphitization or an impregnation vacuum chamber for further densification.

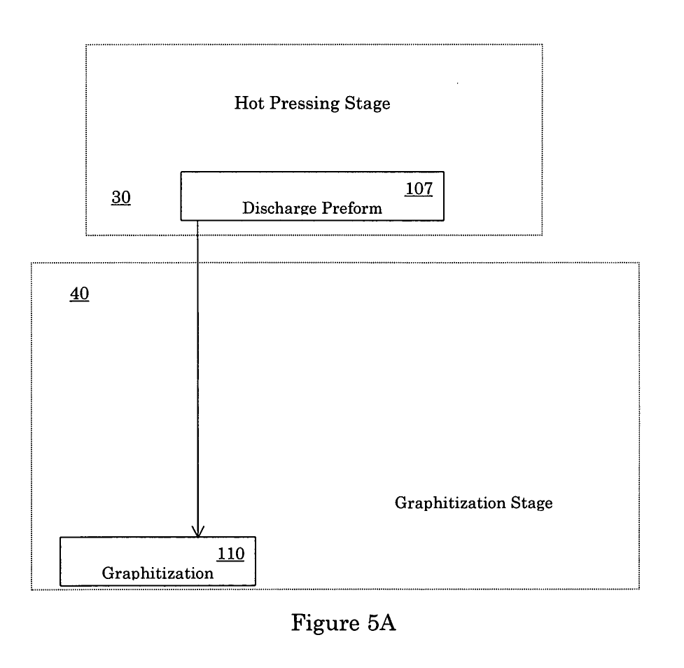

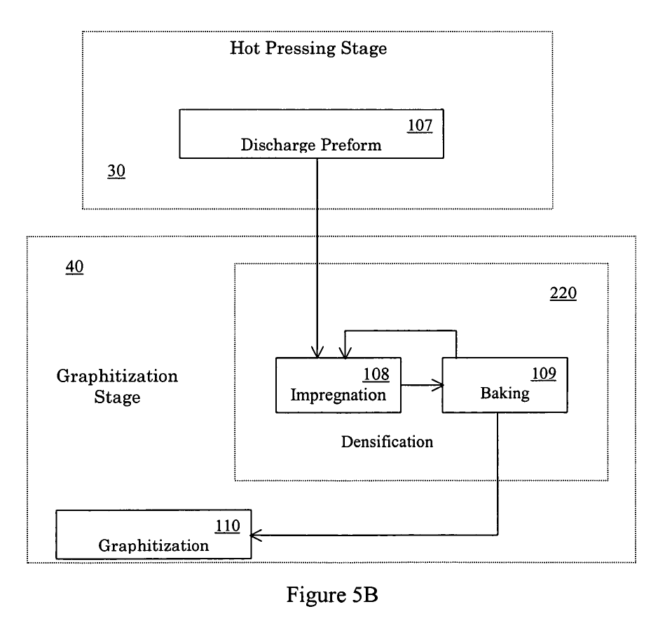

With continued reference to FIG. 1 and now to FIG. 5B, an optional process scheme of the graphitization stage 40 is shown. Further densification of the preform is accomplished as required through one or more densification steps 220 (Step 8 108 and Step 9 109). In a densification step 220 (Step 8 108 and Step 9 109), pitch or other suitable carbonizable material is impregnated into the preform. In one embodiment, each impregnation step, Step 8 108, is accomplished in an impregnation vacuum chamber. After each impregnation step, Step 8 108, the preform is preferably rebaked in Step 9 109 to carbonize the pitch. In Step 9 109, the preform is heated in a furnace, or optionally, resistively heat in the hot press mold or equivalent structure. Since the preform was produced by the hot pressing step, Step 11 111 (Steps 5 and 6 105, 106), and is therefore initially denser, fewer densification steps 220 (Step 8 108 and Step 9 109) are required to achieve the desired density, as compared to conventional methods. Advantageously, having fewer impregnation and carbonization cycles reduces the overall densification time.

With continued reference to FIG. 1 and now to FIG. 5A, a preferred process scheme of the graphitization stage 40 is shown wherein densification step 220 (Step 8 108 and Step 9 109) is eliminated and the preform is directly subjected to a graphitization process, Step 10 110. In this step, the preform is heated in an inert atmosphere, for example, in an induction furnace, to a temperature of about 1500° C., or higher, more preferably, about 2000° C., most preferably, about 2400° C., to remove all (or substantially all) hydrogen and other heteroatoms and produce a graphite electrode or pin. Above about 2400° C., the composite is fully graphitized. The graphitization temperature is selected according to the end use of the final product and is generally above the highest temperature to which the electrode or pin is to be subjected in use.

Generally, process time for the initial baking and impregnation/rebaking cycles of conventional methods is a significant contributor to the overall process time of making carbon bodies, such as graphite electrodes and pins, by those methods. In the present invention, the hot pressing step, Step 11 111 (Steps 5 and 6 105, 106) provides a significant reduction in the process time required to initially carbonize an stock mixture. Exemplary preform process times include a process time of about 5 minutes for a 50 lbs carbon body such as a pin and a preform process time of about 6 hour for a 2000 lbs carbon body such as an electrode.

In the present invention, the density of the preform body, such as a preform electrode or pin, formed in the hot pressing step, Step 11 111 (Steps 5 and 6 105, 106), is much higher than the density generally achieved in conventional methods. As a consequence, fewer densification cycles 220 are used to achieve a final desired density with the method of the present invention than with conventional methods of baking and rebaking green electrodes or pins. This decreases the number of processing steps and reduces the overall processing time even further. For example, where six or more impregnation steps are sometimes used in a conventional process for forming carbon pins, one embodiment of the present process provides a carbon pin having a comparable final density in only one or two impregnation steps.

The process times achievable by implementation of the method of the present invention in the production of carbon electrodes and pins represent a significant shortening of manufacturing process lead times, as compared to conventional methods. In exemplar processes of the present invention, the overall manufacturing process time to form a graphite pin or a graphite electrode is about 10 days for either, as compared to 6 months and 35 days respectively for conventional methods. Such shortened lead times (i.e. overall manufacturing process time) require much smaller inventories of raw, in process and finished goods to accommodate fluctuations in both the demand for the finished goods and the supply of raw materials. Since the hot pressing step, Step 11 111 (Steps 5 and 6 105, 106), requires significantly less process time than the initial baking step of conventional methods, the throughput of the manufacturing processes is increased. Similarly, the reduction in the number of densification cycles achieved by the practice of the method of this invention results in even more saving in process time and further increases throughput. Increased throughput allows significant reduction in equipment and labor. Carbon bodies produced by the method of the present invention are produced with significant reduction in lead time and with significant savings in capital cost, inventory carrying cost and labor expense.

Thus, although the present invention has been described with reference to the preferred embodiment of a new and useful Improved Process for the Production of Carbon Bodies, it is not intended that such references be construed as limitations upon the scope of this invention except as set forth in the appended claims. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method of forming a carbon body comprising the steps of:
(a) combining a coke material, a pitch material to form a stock mixture;
(b) resistively and compressively heating the stock mixture so as to form an at least partially carbonized preform body, the step of resistively and compressively heating including:
applying an electric current to the stock mixture to generate heat within the stock mixture; and
applying pressure to the stock mixture.

2. The method of claim 1 wherein step (b) includes resistively and compressively heating the stock mixture for a process time.

3. The method of claim 2 wherein step (b) further includes concurrently applying both said electric current and said pressure for at least a portion of said process time.

4. The method of claim 2, wherein step (b) includes:
a programmed application of said electric current and said pressure for said process time, said programmed application adapted to control the temperature of the stock mixture.

5. The method of claim 2, wherein step (b) further comprises:
a programmed application of said electric current and said pressure for said process time, said programmed application adapted to control the pressure of the stock mixture.

6. The method of claim 1, wherein the pitch material has a carbonization temperature, and
wherein step (b) further comprises heating the stock mixture to a temperature greater than the carbonization temperature of the pitch material.

7. The method of claim 6, wherein the stock mixture is heated to a temperature of between about 700° C. and about 1100° C.

8. The method of claim 1, further comprising the step of:
heating the preform body to a final temperature of at least about 1500° C. so as to at least partially graphitize the carbonized preform body.

9. The method of claim 1, further comprising the step of:
heating the preform body in an inert atmosphere to a final temperature of about 2400° C. so as to substantially completely graphitize the carbonized preform body.

10. The method of claim 1 wherein said pitch material comprises pitches having coking yields of at least about 70%.

11. The method of claim 10 wherein said pitch material comprises pitches having coking yields of at least about 80%.

12. The method of claim 4, wherein said resistive and compressive heating step includes:
applying a first power level of electrical current for a first portion of said process time so as to heat the stock mixture to a first temperature; and
applying a second power level of electrical current for a second portion of said process time so as to heat the stock mixture to a second temperature, said second temperature being higher than said first temperature.

13. The method of claim 12, wherein the pitch material has a carbonization temperature, and
wherein said second temperature is higher than said carbonization temperature and said carbonization temperature is higher than said first temperature.

14. The method of claim 4, wherein said resistive and compressive heating step further includes:
applying a first pressure to the stock mixture for a first portion of said process time; and
applying a second pressure to the stock mixture for a second portion of said process time, said second pressure being higher than said first pressure.

15. A method of forming a graphite body comprising the steps of:
(a) compressing a carbonizable stock material comprising a coke material, a pitch material and a carbon fiber material;
(b) during the step of compressing, applying a current to the mixture, the mixture providing a sufficient electrical resistance to the current such that the mixture reaches a temperature sufficient to form an at least partially carbonized preform; and
(c) graphitizing the impregnated preform to a final temperature of at least about 1500° C. to form the graphite body.

16. The method of claim 15 wherein said carbonizable stock material comprises either a carbonizable stock mixture or a green carbon body.

17. The method of claim 16, wherein said pitch material has a softening point temperature, and
wherein said mixing step further including the step of:
heating the coke material and the pitch material to a temperature above said softening point temperature.

18. The method of claim 17 further including the step of:
molding the carbonizable stock mixture so as to form a green carbon body.

19. The method of claim 15 further including the steps of:
providing a hot press assembly, said hot press assembly having:
a hydraulic press;
a hot press mold having a shaped mold cavity, said cavity including electrical contacts; and
an electrical power supply circuit adapted to provide an electrical current to the hot press mold;
placing said carbonizable stock material within said cavity; and
operating said hot press assembly so as to accomplish steps (a) and (b).
